(19) United States
(12) Patent Application Publication
(10) Pub. No.: US 2009/0183492 A1
(43) Pub. Date: Jul. 23, 2009

(54) COMBUSTION LEAN-BLOWOUT PROTECTION VIA NOZZLE EQUIVALENCE RATIO CONTROL

(75) Inventors: Timothy Andrew Healy, Simpsonville, SC (US); Garth Curtis Frederick, Greenville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/017,507

(22) Filed: Jan. 22, 2008

(51) Int. Cl. F02C 9/28

(52) U.S. Cl. 60/39.281; 701/100

(57) ABSTRACT

Disclosed is a method and system for controlling a combustor of a gas turbine utilizing fuel nozzle equivalence ratio. The equivalence ratio of at least one fuel nozzle of the combustor, the combustor having at least one fuel nozzle disposed in at least one combustor can, is measured. The measured equivalence ratio is compared to a threshold value for lean blowout. The fuel flow from the at least one nozzle is modified thereby adjusting the equivalence ratio to prevent lean blowout.

### BACKGROUND

The subject invention relates to gas turbines. More particularly, the subject invention relates to control of combustors of gas turbines.

A typical gas turbine has a plurality of combustors, and each combustor may include a quantity of cans, which in turn include a number of individual nozzles. Fuel/air mix may be routed to individual nozzles in unequal amounts, depending on the operating conditions of the combustor. The ratios of these amounts are vernacularly referred to as fuel splits. Fuel flow to the individual burner tubes is regulated in order to control combustion dynamics to achieve a desired load and/or combustion temperature, and to control emissions of, for example, NOₓ and CO₂. To minimize emissions of NOₓ, it is often desired to operate the turbine with a lean fuel mixture (one where the fuel to air ratio is low), but as the fuel mixture in the combustor gets leaner and leaner to minimize NOₓ emissions, the risk of lean blow out (LBO) increases, especially at certain operating conditions of the gas turbine. LBO is a phenomenon where there is not enough fuel in the combustion chamber relative to the amount of air in the chamber, and the combustor fails to ignite the mixture. To prevent LBO, a combustor-level fuel to air ratio, which is adjusted for the fuel splits between burner tubes, is scheduled versus combustor severity parameter, which is a function of combustor load, pressure, temperature, and relative humidity. For a particular severity parameter value, a combustor-level fuel to air ratio is prescribed to prevent LBO. This method of preventing LBO produces conservative results when the combustor is at extremities of the operating envelope, particularly cold day and/or low load. Additionally, the current method presumes that all nozzles are in operation, which is not the case in some circumstances, for example startup of the combustor.

### BRIEF DESCRIPTION OF THE INVENTION

The present invention solves the aforementioned problems by providing a method and system for controlling a combustor of a gas turbine utilizing fuel nozzle equivalence ratio. The equivalence ratio of at least one fuel nozzle of the combustor, the combustor having at least one fuel nozzle disposed in at least one combustor can, is measured. The measured equivalence ratio is compared to a threshold value for lean blowout. The fuel flow from the at least one nozzle is modified thereby adjusting the equivalence ratio to prevent lean blowout.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic cross-sectional view of a combustor can;

FIG. 2 is a schematic graph of equivalence ratio versus severity parameter; and

FIG. 3 is a schematic graph of nozzle-level equivalence ratio versus severity parameter.

The detailed description explains embodiments of the invention, together with advantages and features, by way of example with reference to the drawings.

### DETAILED DESCRIPTION OF THE INVENTION

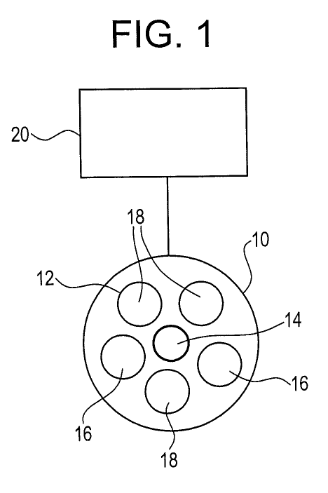

Shown in FIG. 1 is a cross-section of a gas turbine combustor can 10. A gas turbine combustor (not shown) may include one or more cans 10 distributed throughout the combustor. The can 10 is generally annular in shape. In FIG. 1, the can 10 includes six individual nozzles 12 through which a fuel/air mix is injected into the can 10 for combustion. The nozzles 12 of this embodiment comprise a PM1 nozzle 14 disposed in substantially a center of the can 10. Two PM2 nozzles 16 and three PM3 nozzles 18 are include in the can 10 and are arrayed to, together, encircle the PMI 1 nozzle 14. It is to be appreciated that other quantities of nozzles 12, for example, 1, 14, or 18 may be utilized in combustor cans 10 of the present invention. The embodiment of FIG. 1, utilizing six nozzles 12 is merely an example for illustrative purposes.

A manifold, schematically shown at 20, mixes fuel and air and regulates the flow of the fuel air mixture through the nozzles 12. The manifold 20 divides fuel/air mix flow into separate circuits such that differing volumes of fuel/air mix, and different fuel/air mixture ratios can be provided to each group of nozzles, PM1 nozzle 14, PM2 nozzles 16, and PM3 nozzles 18.

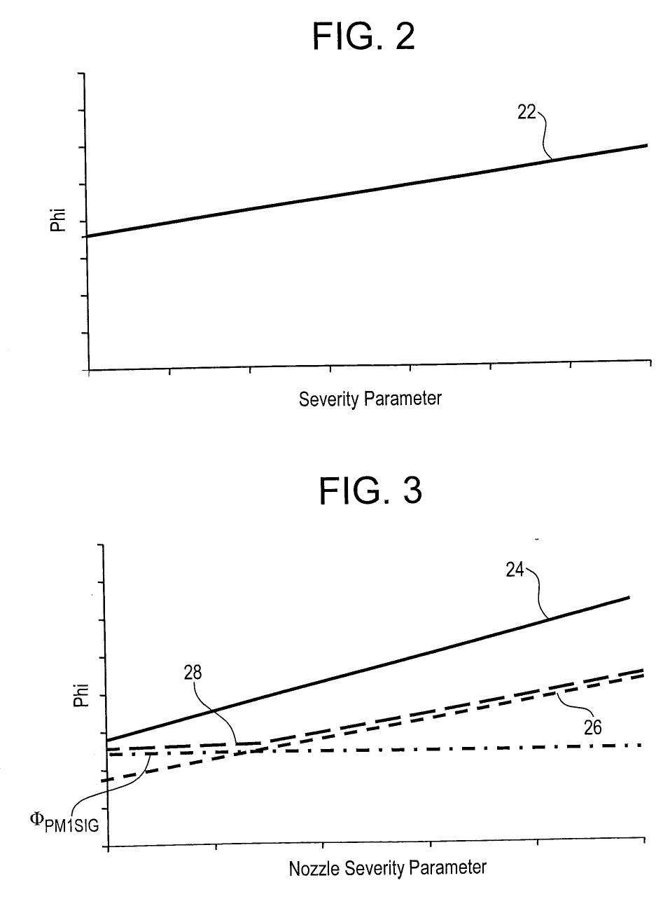

Equivalence ratio or phi (Φ) for the combustor is defined as a ratio of an actual fuel-to-air ratio (W_{fuel}/Wₐᵢᵣ) to a stoichiometric fuel-to-air ratio (Ws_{fuel}/Wsₐᵢᵣ). In general, for given combustion conditions, for example, load, pressure, temperature, and relative humidity, the lower the value of Φ, the leaner the fuel-to-air ratio, and the greater likelihood of lean blowout (LBO). Since severity parameter is a function of load, pressure, temperature, and relative humidity, Φ can be plotted versus severity parameter as illustrated in FIG. 2. A resultant LBO line 22, allows the scheduling of Φ versus severity parameter, such that for a given severity parameter that the combustor 10 is operating at, a minimum (D is prescribed to prevent LBO.

To protect against LBO in the operating conditions, such as startup, when not all of the groups of nozzles, PM1 nozzle 14, PM2 nozzles 16, and PM3 nozzles 18, are operating, LBO lines 22 are determined for specific groups of nozzles. In one embodiment, LBO prevention is provided by scheduling Φ of PM1 nozzle 14 (Φ_{PM1}) and Φ of PM3 (Φ_{PM3}) versus severity parameter. For the PM1 nozzle 14, Φ_{PM1} is the ratio of an actual PM1 fuel-to-air ratio (W_{fuel}/Wₐᵢᵣ)_{PM1} to a stoichiometric PM1 fuel-to-air ratio (Ws_{fuel}/Wsₐᵢᵣ)_{PM1}. A schematic PM1 LBO line 24 of a minimum Φ_{PM1} versus severity parameter is shown in FIG. 3. Similarly, a schematic PM3 LBO line 26 is established plotting minimum Φ_{PM3} versus severity parameter. In this embodiment, control of Φ_{PM1} and Φ_{PM3} is controls a minimum quantity of nozzles 12 sufficient to stabilize a main flame and prevent LBO. Control of Φ_{PM1} and Φ_{PM3} in this embodiment is merely an illustrative example, and it is to be appreciated that Φ minimum quantity of nozzles 12 for which Φ must be controlled to prevent LBO may vary and depends on combustor configuration, for example, number of nozzles 12 or number of fuel circuits per can 10, or operating conditions. Utilizing a nozzle-level Φ as described to prevent LBO offers accurate LBO prevention over an increased range of operating conditions, especially those at low severity parameter values, and the calculation of nozzle-level Φ is real-time, allowing for correction of fuel flow to prevent LBO if Φ reaches a threshold level.

In operation, at a particular severity parameter corresponding to machine operating conditions, an equivalence ratio of a desired quantity of nozzles 12 is measured and compared to a threshold value. The threshold value corresponds to the value of Φ on, for example, line 24 for PM1, for the given severity parameter. Adjustments to Φ if it falls below, or near, the threshold may be accomplished by adjusting the fuel flow and/or the fuel/air mix from the manifold 20 to one or more of the nozzles 12.

In some embodiments, it may be desirable to modify the PM1 LBO line 24, to incorporate a minimum Φ_{PM1} at which there are other detrimental effects on combustor performance, for example, an undesirable dynamic signature. This is shown as Φ_{PM1SIG} in FIG. 3. PM1 LBO line 24 and Φ_{PM1SIG} are combined resulting in a minimum Φ_{PM1} shown as line 28 which establishes a Φ_{PM1} which is utilized to prevent both LBO and the undesirable dynamic signature. In some embodiments, Φ_{PM1SIG} may be established on a combustor-by-combustor basis utilizing a tuning procedure described below, thus establishing an accurate minimum threshold for Φ_{PM1}. For example, the combustor is loaded to 100% load. A fuel flow to the PM3 nozzles 18 is then adjusted to obtain a can dynamic signature, which in some cases may be approximately 2 psi. The PM1 nozzle 14 flow is then reduced until a shift is observed in the dynamic signature, to approximately 3-4 psi. The phi for the PM1 nozzle 14 at the point where the shift occurs is Φ_{PM1SIG}. Utilization of nozzle-level Φ to prevent the undesirable dynamic signature is shown by way of example, and it is to be appreciated that other detrimental effects which occur at a known nozzle-level Φ or range of nozzle-level Φ may be prevented by monitoring nozzle-level Φ to prevent the detrimental effect.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for controlling a combustor of a gas turbine comprising:
measuring an equivalence ratio of at least one fuel nozzle of the combustor, the combustor including at least one fuel nozzle disposed in at least one combustor can;
comparing the equivalence ratio to a threshold value for lean blowout; and
modifying a fuel flow from the at least one nozzle thereby adjusting the equivalence ratio to prevent lean blowout.

2. The method of claim 1 wherein the at least one fuel nozzle includes at least one center fuel nozzle disposed substantially in a center of at least one combustor can.

3. The method of claim 2 wherein the at least one fuel nozzle further includes a plurality of outer fuel nozzles encircling the at least one nozzle disposed substantially in a center of at least one combustor can.

4. The method of claim 3 wherein a first threshold value for the center fuel nozzle substantially differs from a second threshold value for the plurality of outer fuel nozzles.

5. The method of claim 1 wherein the fuel flow is modified by changing a fuel to air ratio of fuel provided to the at least one nozzle.

6. The method of claim 5 wherein the fuel to air ratio is modified by a manifold.

7. The method of claim 1 including:
establishing a minimum equivalence ratio for the at least one fuel nozzle necessary to avoid an undesirable dynamic signature;
comparing the equivalence ratio to the minimum equivalence ratio; and
modifying a fuel flow from the at least one nozzle thereby adjusting the equivalence ratio to prevent the undesirable dynamic signature.

8. The method of claim 7 wherein the at least one fuel nozzle includes at least one center fuel nozzle disposed substantially in a center of at least one combustor can.

9. The method of claim 7 wherein the minimum equivalence ratio is determined on a combustor-by-combustor basis.

10. The method of claim 7 wherein establishing the minimum equivalence ratio includes:
loading the combustor to a desired load level;
adjusting a fuel flow from the at least one nozzle to produce a first level of the dynamic signature;
further adjusting the fuel flow from the at least one nozzle until the dynamic signature shifts to an undesirable level; and
measuring the equivalence ratio at the point where the dynamic signature shifts.

11. The method of claim 10 wherein the first level is approximately 2 psi.

12. The method of claim 11 wherein the undesirable level is approximately 3-4 psi.

13. The method of claim 10 wherein the desired load level is approximately 100% load.

14. A system for controlling a combustor of a gas turbine comprising:
means for measuring an equivalence ratio of at least one fuel nozzle of the combustor the combustor including at least one fuel nozzle disposed in at least one combustor can;
means for comparing the equivalence ratio to a threshold value for lean blowout; and
a manifold for modifying a fuel flow from the at least one nozzle which adjusts the equivalence ratio to prevent lean blowout.

15. The system of claim 14 wherein the manifold adjusts the equivalence ratio by changing a fuel to air ratio of fuel provided to the at least one nozzle.

16. The system of claim 14 including:
means for establishing a minimum equivalence ratio for the at least one fuel nozzle necessary to avoid an undesirable dynamic signature;
wherein the means for comparing compares the equivalence ratio to the minimum equivalence ratio; and
wherein the manifold adjusts the equivalence ratio to prevent the undesirable dynamic signature.

17. The system of claim 16 wherein the means for establishing the minimum equivalence ratio:
loads the combustor to a desired load level;
adjusts a fuel flow from the at least one nozzle to produce a first level of the dynamic signature;
further adjusts the fuel flow from the at least one nozzle until the dynamic signature shifts to an undesirable level; and
measures the equivalence ratio at the point where the dynamic signature shifts.

18. The system of claim 17 wherein the first level is approximately 2 psi.

19. The system of claim 18 wherein the undesirable level is approximately 3-4 psi.

20. The method of claim 17 wherein the combustor is loaded to the desired of approximately 100% load.
